(19) United States
(12) Patent Application Publication
(10) Pub. No.: US 2005/0114790 A1
(43) Pub. Date: May 26, 2005

(54) User interface

(76) Inventors: Christopher Dunbar, Salthill (IE); John Donohoe, Galway (IE); Eoin Mooney, Galway (IE); Tommy A. Morris, Galway (IE)

Correspondence Address: BARNES & THORNBURG, P.O. BOX 2786, CHICAGO, IL, 60690-2786, US

(21) Appl. No.: 10/922,273

(22) Filed: Aug. 19, 2004

Related U.S. Application Data
(60) Provisional application No. 60/524,635, filed on Nov. 24, 2003.

(51) Int. Cl. G06F 3/00

(52) U.S. Cl. 715/785; 715/784; 715/829; 715/830; 715/973; 715/974; 715/833; 715/834; 715/804; 715/805; 715/760; 715/734; 715/738; 715/712; 715/713; 715/853; 715/854; 715/855

(57) ABSTRACT

A graphical user interface displays a plurality of sections of information. Each section has a heading which comprises a link. The links can be selected by a user to collapse or expand information in the section. In addition, automatic scrolling takes place to scroll expanded information substantially into view. When a section is collapsed or expanded the associated heading is marked for a pre-specified time to aid the user in returning his or her attention to the appropriate region of the display, despite the use of the automatic scrolling. In addition, marks are used to indicate regions of the display where user entered information needs to be added or corrected.

### RELATED APPLICATION

This application is the full utility filing of U.S. provisional application No. 60/524,635 filed on 24 Nov. 2003 from which the present application claims priority and which is incorporated herein by reference.

### FIELD OF THE INVENTION

The present invention relates to user interfaces and is particularly related to but in no way limited to web-based user interfaces.

### BACKGROUND TO THE INVENTION

Graphical user interfaces are known for use in displaying data to users, where large amounts of data are to be displayed even though it is not possible to display all that data on a single display screen. One approach to this problem has been to use a tree-like, hierarchical structure for ordering the data and displaying or hiding data at different levels in the hierarchy according to user selections.

For example, in the well-known Microsoft Windows Explorer (trade mark) system, items in a file structure are displayed in a panel along one side of a display screen. The signs “+” and “−” are used next to each item in the display to indicate whether further items are to be revealed by selecting that item. When a “+” sign is selected the item list expands to show items at a lower level in the file structure hierarchy. When a “−” sign is selected the item list collapses to hide items at the lower level. In this manner information is displayed or hidden as a result of user selections. By doing this, the user is able to deal more effectively with large amounts of information than he or she would have been able to when presented with a full listing. However, one problem with this method of collapsing and expanding information displayed on the screen is that users can easily lose their place within the information when the action of collapsing or expanding takes place. This problem is especially apparent when large amounts of data are involved which cannot easily be displayed on a single display screen or window.

Another approach to dealing with large amounts of information to be displayed in a limited presentation area is to use a scroll bar or mechanism. This well known approach involves the user making a selection on a scroll bar on the screen or by rolling a button on a mouse. These actions cause the information on the display to scroll. One problem with this approach is that the use must make the selection using the scroll bar, mouse, keyboard or other user input device. This action causes the user to move his or her attention away from the current task in order to effect the scrolling. The user must then return his or her attention as appropriate.

Graphical user interfaces are often used to enable a user to enter data to a system. It is known to use a checking or verification method in this type of situation and to inform the user if the information is not in the required form or contains errors or omissions. Typically the results of the checking or verification process are provided in the form of a separate report or by listing the results at the end of the graphical user interface display. This is problematic for users who, having obtained the checking results, need to go back to and find relevant parts of the user interface which is time consuming, complex and leads to errors.

### OBJECT TO THE INVENTION

The invention seeks to provide a method of displaying data using a graphical user interface and a graphical user interface which overcome or at least mitigate one or more of the problems mentioned above.

Further benefits and advantages of the invention will become apparent from a consideration of the following detailed description given with reference to the accompanying drawings, which specify and show preferred embodiments of the invention.

### SUMMARY OF THE INVENTION

A graphical user interface displays a plurality of sections of information. Each section has a heading which comprises a link. The links can be selected by a user to collapse or expand information in the section. In addition, automatic scrolling takes place to scroll expanded information substantially into view. When a section is collapsed or expanded the associated heading is marked for a pre-specified time to aid the user in returning his or her attention to the appropriate region of the display, despite the use of the automatic scrolling. In addition, marks are used to indicate regions of the display where user entered information needs to be added or corrected.

According to an aspect of the present invention there is provided a method of displaying data using a graphical user interface, said data being formed into a plurality of sections of information; said method comprising the steps of:
displaying a heading for each of the sections of information, each heading comprising a link which when selected causes the associated section of information to be expanded or collapsed;
providing a scrolling mechanism arranged such that the user is able to scroll information displayed on the graphical user interface;
arranging said scrolling mechanism to be automatically activated when one of the links is selected to expand a section of information, such that the scrolling mechanism acts to bring the expanded section of information substantially into view within the graphical user interface;
in the event that one of the links is selected, marking the associated heading.

By using the links in the headings the user is able to collapse and expand information displayed on the screen and this helps the user to deal with large amounts of information. Also, the automatic or forced scrolling mechanism ensures that the expanded information is displayed optimally within the graphical user interface. That is, the user does not need to make a scrolling action themselves to bring the expanded information into view. This is particularly advantageous because the user can retain attention on the main part of the display rather than a scroll mechanism. Also, because the marking is used to indicate the heading of the expanded information, the user is able to retain or direct his or her attention to the relevant part of the display, despite the fact that forced or automatic scrolling has been used.

Preferably the method further comprises the step of removing the mark when a pre-specified condition is met. For example, when a time limit expires. The mark can be made in any suitable manner such as by highlighting in order to bring the users attention back to the place where he or she just clicked or made a selection. This provides a simple and effective means of enabling the user to direct his or her attention appropriately.

The step of marking the associated heading is carried out when a section of information is expanded and/or when a section of information is collapsed. In both these situations, forced or automatic scrolling may occur and without the marking, the user can easily lose attention on the required part of the display.

Preferably the method further comprises arranging the scrolling mechanism to be automatically activated when one of the links is selected to collapse a section of information, such that the scrolling mechanism acts to bring the heading of the collapsed section of information substantially into view within the graphical user interface.

In one example the graphical user interface is web-based. This makes implementation of the links particularly effective because hyper text or other suitable web links can be used.

Advantageously, implementation of the graphical user interface is simplified because the number of individual files and other components needed is reduced. For example, in previous non web-based and web-based GUIs multiple layers, HTML files and Java (trade mark) scripts have typically been used to provide sections of information and processing required to display these appropriately. However, management of those layers, HTML files and scripts has been complex. Preferably said sections of information are provided in a single file together with computer software arranged to control a display such that the steps of the method are performed. This is advantageous because the single file is simple to reference and manage as well as be transmitted between entities on a communications network. This is particularly advantageous in the case of web-based interfaces where only a single file needs to be accessed by a browser at a user terminal.

In another embodiment the method comprises checking that data entered by a user within one or more of the sections meets pre-specified conditions and, on the basis of the checking process, marking one or more regions of the graphical user interface. In that case, the method preferably further comprises expanding one or more of the sections and automatically activating the scrolling mechanism such that one or more of the marked regions are substantially in view within the graphical user interface. This provides the advantage that the user can quickly and easily identify regions where data needs to be corrected or entered and does not need to refer to a separate part of the interface.

The invention also encompasses a graphical user interface suitable for displaying data, said data being formed into a plurality of sections of information; said graphical user interface comprising:
a display arranged to display a heading for each of the sections of information, each heading comprising a link which when selected causes the associated section of information to be expanded or collapsed;
a scrolling mechanism arranged such that the user is able to scroll information displayed on the graphical user interface, said scrolling mechanism arranged to be automatically activated when one of the links is selected to expand a section of information, such that the scrolling mechanism acts to bring the expanded section of information substantially into view within the graphical user interface;
a processor arranged, in the event that one of the links is selected, to mark the associated heading.

According to another aspect of the invention there is provided a graphical user interface suitable for displaying data, said data being formed into a plurality of sections of information; said graphical user interface comprising:
means for displaying a heading for each of the sections of information, each heading comprising a link which when selected causes the associated section of information to be expanded or collapsed;
a scrolling means for enabling the user to scroll information displayed on the graphical user interface, said scrolling means being automatically activated when one of the links is selected to expand a section of information, such that the scrolling means acts to bring the expanded section of information substantially into view within the graphical user interface;
marking means for, in the event that one of the links is selected, marking the associated heading.

The invention also provides for a system for the purposes of digital signal processing which comprises one or more instances of apparatus embodying the present invention, together with other additional apparatus.

The preferred features may be combined as appropriate, as would be apparent to a skilled person, and may be combined with any of the aspects of the invention.

### BRIEF DESCRIPTION OF THE DRAWINGS

In order to show how the invention may be carried into effect, embodiments of the invention are now described below by way of example only and with reference to the accompanying figures in which:

FIG. 1 shows part of a graphical user interface according to the prior art;

FIG. 2 shows part of a graphical user interface with a plurality of collapsed sections of information;

FIG. 3 shows part of the graphical user interface of FIG. 2 with one of the sections of information expanded;

FIG. 4 shows part of the graphical user interface of FIG. 2 with two of the sections of information expanded and after forced scrolling;

FIG. 5 shows part of the graphical user interface of FIG. 2 with two of the sections of information expanded and one of the section headings highlighted after expansion of that section;

FIG. 6 shows part of the graphical user interface of FIG. 2 with one of the section headings highlighted after collapsing of that section;

FIG. 7 shows part of the graphical user interface of FIG. 2 with one of the sections expanded and a region highlighted to indicate an error or omission;

FIG. 8 is a flow diagram of a method of displaying data using a graphical user interface.

### DETAILED DESCRIPTION OF INVENTION

Embodiments of the present invention are described below by way of example only. These examples represent the best ways of putting the invention into practice that are currently known to the Applicant although they are not the only ways in which this could be achieved.

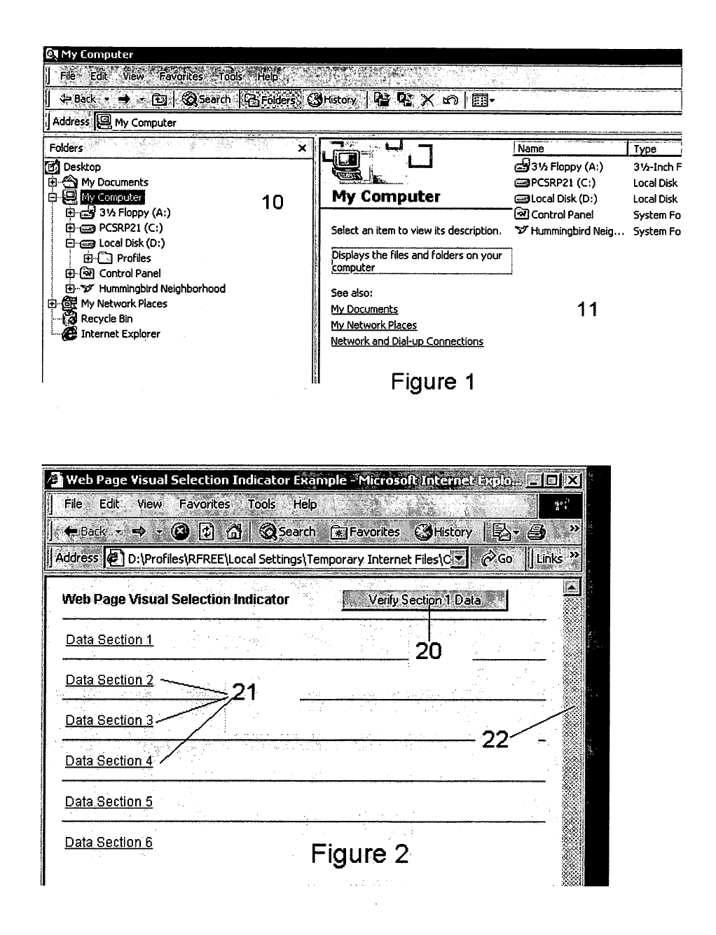

FIG. 1 shows part of a prior art graphical user interface. This example, is from the well-known Microsoft Windows Explorer (trade mark) system. Items in a file structure are displayed in a panel 10 along one side of a display screen 11. As mentioned above the signs “+” and “−” are used next to each item in the display to indicate whether further items are to be revealed by selecting that item. When a “+” or “−” sign is selected the item list expands or collapses. By doing this, the user is able to deal more effectively with large amounts of information than he or she would have been able to when presented with a full listing. However, one problem with this method of collapsing and expanding information displayed on the screen is that users can easily lose their place within the information when the action of collapsing or expanding takes place. This problem is especially apparent when large amounts of data are involved which cannot easily be displayed on a single display screen or window.

The present invention addresses these issues by using a combination of automatic scrolling and marking or highlighting of regions on the display. FIG. 2 shows part of a graphical user interface (GUI) suitable for use in the present invention. A plurality of section headings 21 are displayed, each being associated with a section of information (not shown in this view). A scroll bar 22 or other scroll mechanism is provided as part of the GUI and enables the user to scroll the display to show different parts of the information. Any suitable scroll mechanism can be used as known in the art. The GUI also comprises a button 20 or other user selection region or device which enables the user to active a verification or checking mechanism.

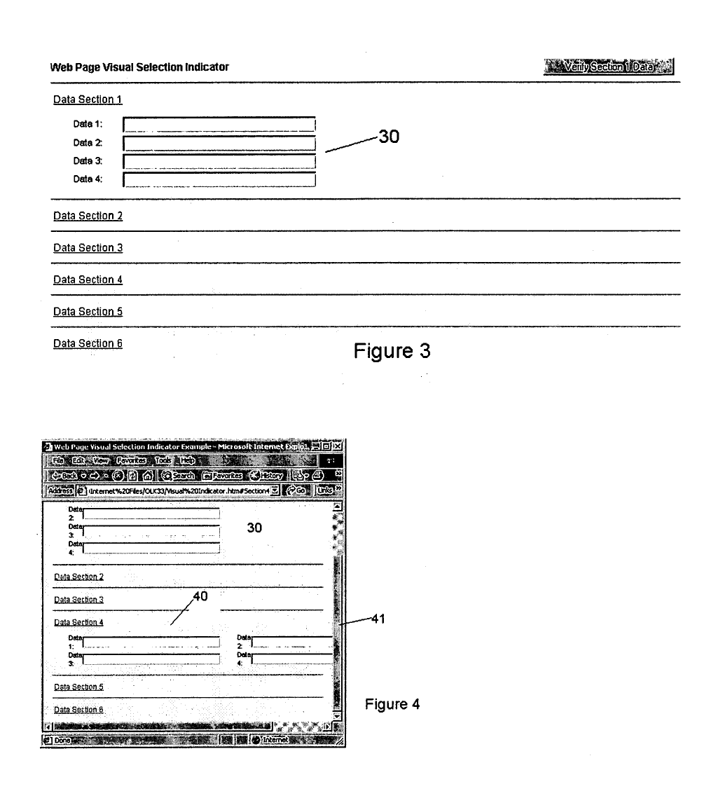

FIG. 3 shows part of the GUI of FIG. 2 with data section 1 expanded. That is, the user has selected the heading “data section 1” which comprises a link to a section of information 30. That information is then displayed. The other section headings can also be expanded in this way and more than one section heading can be expanded at the same time. If the user selects the heading “data section 1” again the section of information 30 collapses such that the display returns to the form shown in FIG. 2.

FIG. 4 shows the GUI of FIGS. 2 and 3. In this case the heading “data section 1” is expanded, as in FIG. 3 and in addition, the heading “data section 4” is expanded 40. Automatic or forced scrolling has taken place to bring the expanded section of information 40 substantially into view within the GUI. Thus the scroll bar 41 has moved downwards as indicated in the Figure.

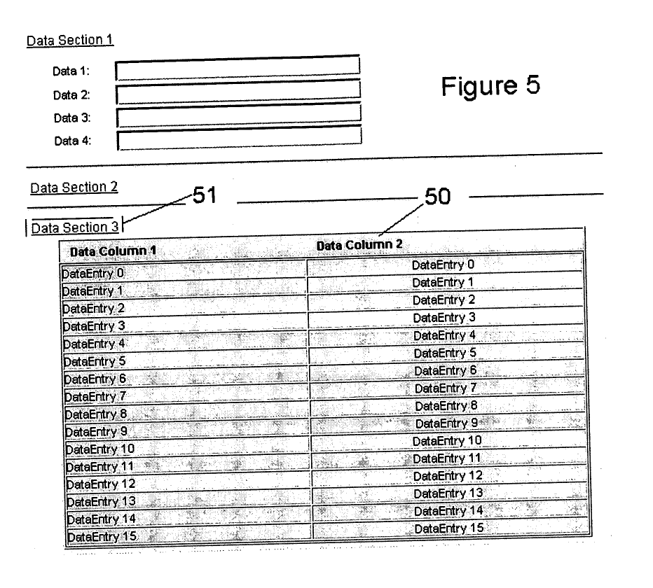

FIG. 5 shows the GUI of FIG. 2 in the situation that the headings “data section 1” and “data section 3” are both expanded. The expanded information 50 is substantially displayed in the GUI as a result of the automatic scrolling, although not all of the information may fit into the display. In addition, the heading “data section 3” is highlighted 51 or marked in any suitable fashion so as to draw the user's attention back to this heading after the automatic scrolling and expansion.

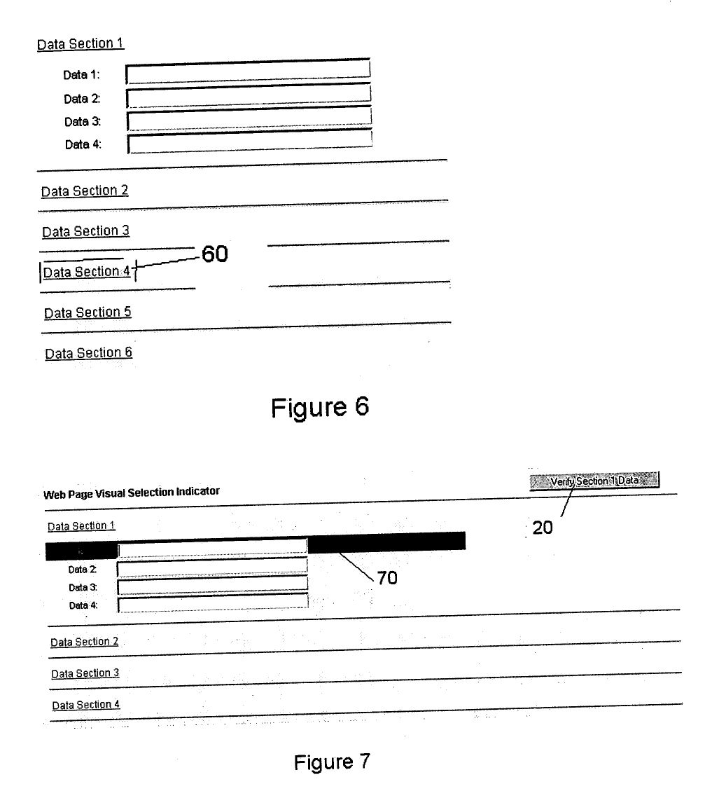

FIG. 6 shows the GUI of FIG. 2 when the heading “data section 4” has just been selected to collapse the information in that section. That heading is marked, highlighted or otherwise indicated to bring the user's attention back to that region of the display.

FIG. 7 shows the situation in which the user has selected the button 20 to activate a checking mechanism. In this situation it is found that data is missing from a field within the “data section 1” section. That section is automatically expanded (without the user needing to select the heading), automatic scrolling takes place if necessary, and the relevant region 70 of the GUI is marked as shown. Any suitable method of marking or drawing the user's attention to the relevant region may be used.

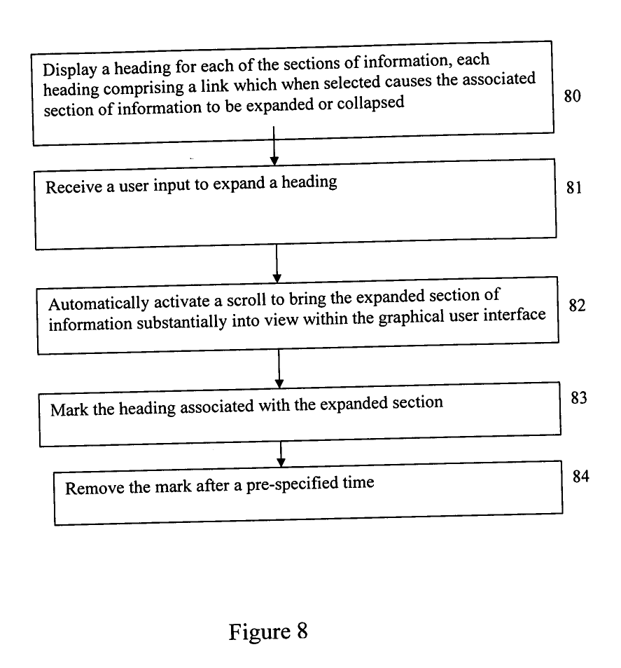

FIG. 8 is a flow diagram of a method of displaying data using a graphical user interface such as that illustrated in FIG. 2. The data comprises sections of information each having a section heading that is displayed. Each section heading comprises a link to the associated information and when that section heading is selected by a user, the associated information is either displayed or removed from the graphical user interface (see box 80). A user input is received to collapse or expand a heading (see box 81) and the display is updated accordingly. A scroll mechanism is automatically activated to bring expanded information substantially into view within the graphical user interface (see box 82). The heading associated with the expanded section is then marked (see box 83) and optionally, this mark is removed after a pre-specified time such as 1-5 seconds.

Any range or device value given herein may be extended or altered without losing the effect sought, as will be apparent to the skilled person for an understanding of the teachings herein.

In a preferred embodiment where the GUI is web-based, the text links are implemented using HTML and Cascading Style Sheets to represent standard web hyperlinks. When a link is clicked a VBScript function is called. This function then displays the data relating to the link clicked. A unique HTML ID corresponding to the text link clicked, is used by the function to implement the highlighting. The background colour of the text link is set to a particular colour, for example yellow. Another VBScript function is then called in order to revert the background colour to its original value. A deliberate time delay is used when calling this function so that the text link appears highlighted for the length of the time delay. The time delay is variable and can be set to any length of time.

Each of the HTML, VBScript and cascading style sheets can be stored separately in individual files but in a preferred embodiment these are incorporated into a single file. The HTML (hyper text mark-up language) and cascading style sheets handle the look of the web-page while the VBScript handles the functionality behind any clicks on the page. For example, the opening and closing of a section, the highlighting of the text and the error highlighting is handled by the VBScript.

1. A method of displaying data using a graphical user interface, said data being formed into a plurality of sections of information; said method comprising the steps of:
(i) displaying a heading for each of the sections of information, each heading comprising a link which when selected causes the associated section of information to be expanded or collapsed;
(ii) providing a scrolling mechanism arranged such that the user is able to scroll information displayed on the graphical user interface;
(iii) arranging said scrolling mechanism to be automatically activated when one of the links is selected to expand a section of information, such that the scrolling mechanism acts to bring the expanded section of information substantially into view within the graphical user interface;
(iv) in the event that one of the links is selected, marking the associated heading.

2. A method as claimed in claim 1 which further comprises the step of removing the mark when a pre-specified condition is met.

3. A method as claimed in claim 2 wherein said pre-specified condition is a time limit.

4. A method as claimed in claim 1 wherein said step of marking the associated heading comprises highlighting the heading.

5. A method as claimed in claim 1 wherein said step of marking the associated heading is carried out when a section of information is expanded.

6. A method as claimed in claim 1 wherein said step of marking the associated heading is carried out when a section of information is collapsed.

7. A method as claimed in claim 1 which further comprises arranging said scrolling mechanism to be automatically activated when one of the links is selected to collapse a section of information, such that the scrolling mechanism acts to bring the heading of the collapsed section of information substantially into view within the graphical user interface.

8. A method as claimed in claim 1 wherein said graphical user interface is web-based.

9. A method as claimed in claim 1 which further comprises checking that data entered by a user within one or more of the sections meets pre-specified conditions and, on the basis of the checking process, marking one or more regions of the graphical user interface.

10. A method as claimed in claim 9 which further comprises expanding one or more of the sections and automatically activating the scrolling mechanism such that one or more of the marked regions are substantially in view within the graphical user interface.

11. A method as claimed in claim 1 wherein said sections of information are provided in a single file together with computer software arranged to control a display such that the steps of the method are performed.

12. A graphical user interface suitable for displaying data, said data being formed into a plurality of sections of information; said graphical user interface comprising:
(i) a display arranged to display a heading for each of the sections of information, each heading comprising a link which when selected causes the associated section of information to be expanded or collapsed;
(ii) a scrolling mechanism arranged such that the user is able to scroll information displayed on the graphical user interface, said scrolling mechanism arranged to be automatically activated when one of the links is selected to expand a section of information, such that the scrolling mechanism acts to bring the expanded section of information substantially into view within the graphical user interface;
(iii) a processor arranged, in the event that one of the links is selected, to mark the associated heading.

13. A graphical user interface as claimed in claim 12 which is web-based.

14. A graphical user interface as claimed in claim 12 wherein said link is a hypertext link.

15. A graphical user interface suitable for displaying data, said data being formed into a plurality of sections of information; said graphical user interface comprising:
(i) means for displaying a heading for each of the sections of information, each heading comprising a link which when selected causes the associated section of information to be expanded or collapsed;
(ii) a scrolling means for enabling the user to scroll information displayed on the graphical user interface, said scrolling means being automatically activated when one of the links is selected to expand a section of information, such that the scrolling means acts to bring the expanded section of information substantially into view within the graphical user interface;
(iii) marking means for, in the event that one of the links is selected, marking the associated heading.
